(19) United States
(12) Patent Application Publication
(10) Pub. No.: US 2011/0145251 A1
(43) Pub. Date: Jun. 16, 2011

(54) SYSTEM AND METHOD FOR CONSTRUCTING NAMED ENTITY DICTIONARY

(75) Inventors: Chang Ki LEE, Daejeon (KR); Myung Gil JANG, Daejeon (KR); Yeo Chan YOON, Seoul (KR); Mi Ran CHOI, Daejeon (KR); Hyun Ki KIM, Daejeon (KR); Pum Mo RYU, Daejeon (KR); Soo Jong LIM, Daejeon (KR); Yi Gyu HWANG, Daejeon (KR); Chung Hee LEE, Daejeon (KR); Hyo Jung OH, Daejeon (KR); Jeong HEO, Daejeon (KR)

(73) Assignee: Electronics and Telecommunications Research Institute, Daejeon (KR)

(21) Appl. No.: 12/787,946

(22) Filed: May 26, 2010

(30) Foreign Application Priority Data
Dec. 15, 2009 (KR) 10-2009-0124980

(51) Int. Cl. G06F 17/30

(52) U.S. Cl. 707/740; 707/E17.09; 707/705; 707/748

(57) ABSTRACT

A system and method for constructing a named entity dictionary are disclosed. The method includes analyzing a structure of collected Web text, extracting tabulated or listed information from the Web text, extracting a named entity from the tabulated or listed information, categorizing the extracted named entity, and registering the categorized named entity in a named entity dictionary.

### CROSS-REFERENCE TO RELATED APPLICATIONS

This application claims priority under 35 U.S.C. §119 to Korean Patent Application No. 10-2009-0124980, filed on Dec. 15, 2009, in the Korean Intellectual Property Office, the disclosure of which is incorporated herein by reference in its entirety.

### TECHNICAL FIELD

The following disclosure relates to a system and method for constructing a named entity dictionary, and more particularly, to a system and method for extracting named entities from information of a specific format in Web text and constructing a dictionary with the extracted named entities.

### BACKGROUND

Various technical attempts have been made to analyze the lingual contents of text written in a wide range of fields such as technology, liberal arts, social studies, etc., including morphological analysis, named entity recognition, sentence analysis, etc.

In order to construct a dictionary by analyzing lingual contents, there are techniques for constructing a named entity dictionary. One of them is a Korea Patent Publication No. 10-2006-042296 entitled “Method and Device for Updating Dictionary with Object Name and Coined Word Extracted from Web Document”. This patent is directed to a technique for extracting Web text in a user-interested field over a network and updating named entities and coined words in a dictionary.

However, the above conventional technology extracts only Web text of a limited user-interested field, excluding information in specific Web text such as tables or lists.

### SUMMARY

Therefore, the present invention has been made in view of the above problems, and it is an object of the present invention to provide a method and system for extracting named entities from Web text including information of a predetermined format such as a table or list and constructing a named entity dictionary with the extracted named entities.

To achieve the above and other objects, the present invention provides a method for constructing a named entity dictionary, including analyzing a structure of collected Web text, extracting tabulated or listed information from the Web text, extracting a named entity from the tabulated or listed information, categorizing the extracted named entity, and registering the categorized named entity in a named entity dictionary.

In accordance with the present invention, the above and other objects can be accomplished by the provision of a system for constructing a named entity dictionary, including a Web text collector for collecting Web text, an information extractor for extracting tabulated or listed information from the Web text, a named entity extractor for extracting a named entity from the tabulated or listed information, and a named entity dictionary for storing the extracted named entity

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a system for constructing a named entity dictionary according to an exemplary embodiment of the present invention;

FIG. 2 illustrates tabulated information included in Web text collected by a Web text collector illustrated in FIG. 1;

FIG. 3 is a block diagram of a named entity extractor illustrated in FIG. 1; and

FIG. 4 is a flowchart illustrating a method for constructing a named entity dictionary according to an exemplary embodiment of the present invention.

### DETAILED DESCRIPTION OF EMBODIMENTS

The advantages and features of the present invention and methods for achieving the advantages and features will be more clearly understood from the following detailed description taken in conjunction with the accompanying drawings. However, the invention is not limited to the embodiments set forth below and can be implemented in various ways. The embodiments of the present invention are provided to complete the disclosure of the invention and assist in a comprehensive understanding of the scope of the invention. It is also intended to be understood that the terminology employed herein is used for the purpose of describing particular embodiments only and is not intended to be limiting since the scope of the present invention will be limited only by the appended claims and equivalents thereof. It must be noted that, as used in this specification and the appended claims, the singular forms “a,” “an,” and “the” include plural referents unless the context clearly dictates otherwise. Also, the terms “comprise” and/or “comprising” should be understood to indicate the presence of a component, step, operation and/or device, not excluding the presence or probability of the presence of one or more other components, steps, operations, and/or devices.

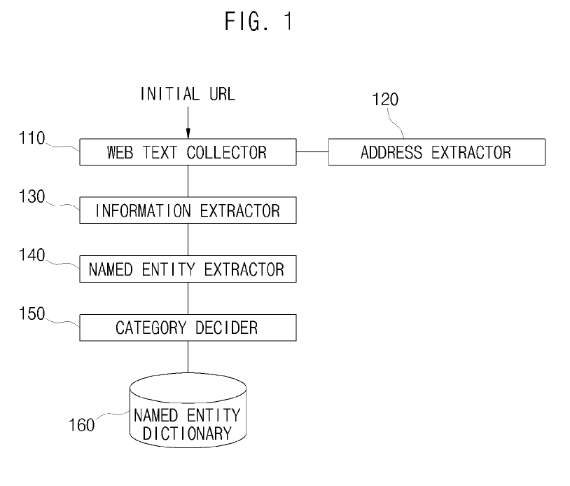

FIG. 1 is a block diagram of a system for constructing a named entity dictionary 160 according to an exemplary embodiment of the present invention.

Referring to FIG. 1, the system includes a Web text collector 110, an address extractor 120, an information extractor 130, a named entity extractor 140, a category decider 150, and the named entity dictionary 160.

The Web text collector 110 collects Web text based on an initial Uniform Resource Locator (URL). The initial URL may be a URL that a person that wants to construct the named entity dictionary 160 has entered or the Web text collector 110 manages separately. The URLs of Web text from which named entities have been extracted and other URLs may be stored in the Web text collector 110. Updated or new Web text may be collected from the stored URLs.

The address extractor 120 extracts the addresses of Web text collected by the Web text collector 110 and outputs the extracted addresses to the Web text collector 110. For example, the address extractor 120 extracts a URL list from Web text by HyperText Markup Language (HTML) parsing of the Web text and transmits the URL list to the Web text collector 110. The Web text collector 110 may manage the addresses received from the address extractor 120 along with the existing addresses.

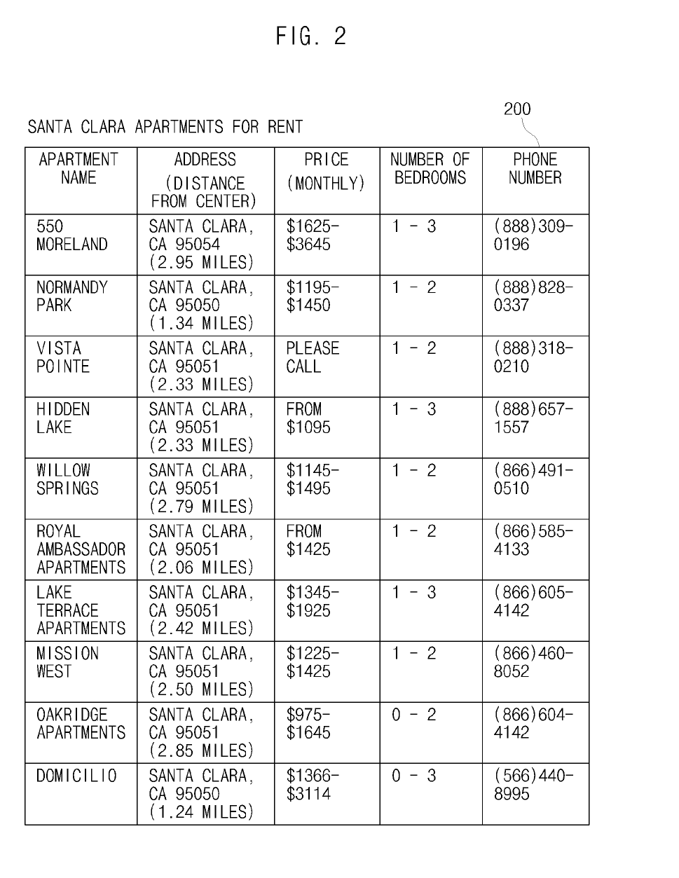

The information extractor 130 extracts tabulated or listed information from the Web text by analyzing the structure of the Web text collected by the Web text collector 110. The Web text includes tabulated information 200 as illustrated in FIG. 2. The information extractor 130 determines whether tabulated or listed information is included in the Web text by analyzing the structure of the Web text, extracts tabulated or listed information from the Web text, in the presence of the tabulated or listed information, and transmits the tabulated or listed information to the named entity extractor 140.

The named entity extractor 140 extracts named entities by performing named entity recognition on the tabulated or listed information. The named entity extractor 140 calculates the probability of a named entity being included in the tabulated or listed information and evaluates the probability as a score. The named entity extractor 140 also evaluates a ratio of actually recognized named entities in the tabulated or listed information as a score. Then the named entity extractor 140 determines named entities to be registered in the named entity dictionary 160 based on the scores. The configuration of the named entity extractor 140 will be described later in more detail.

The named entity dictionary 160 stores the named entities extracted by the named entity extractor 140 in a database. The named entities may be processed in the category decider 150 before being provided to the named entity dictionary 160. The category decider 150 classifies the categories of the extracted named entities so that the named entities may be stored in the named entity dictionary 160 by category.

When the named entities are extracted and their categories are decided, a feedback indicating that the current Web text includes named entities is transmitted to the Web text collector 110. The Web text collector 110 thus manages the URL of the current Web text separately. The Web text collector 110 may give priority to Web text linked to the Web text including named entities and collect them first of all.

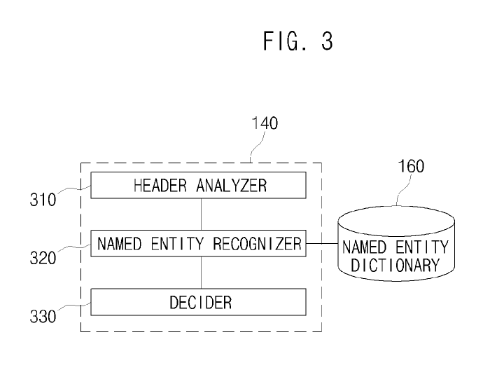

FIG. 3 is a block diagram of the named entity extractor 140. Referring to FIG. 3, the named entity extractor 140 includes a header analyzer 310, a named entity recognizer 320, and a decider 330. The header analyzer 310 analyzes the header of tabulated or listed information, calculates the probability of a named entity being included in the tabulated or listed information based on the analyzed header information, and evaluates the probability as a score. For instance, upon receipt of tabulated information extracted from Web text, the named entity extractor 140 analyzes the header of the tabulated information. If there is no probability that the tabulated information includes a named entity, a low score will be given to the tabulated information. If there is a high probability that the tabulated information includes a named entity, a high score will be given to the tabulated information.

The named entity recognizer 320 performs named entity recognition on the tabulated or listed information. The ratio of recognized named entities may vary depending on the contents of the tabulated information. The named entity recognition ratio may be evaluated as a score. In this case, the named entity recognizer 320 may perform the named entity recognition using the named entity dictionary 160 that has already been constructed as a database.

For the convenience' sake of description, the score calculated by the header analyzer 310 and the score calculated by the named entity recognizer 320 are referred to as first and second scores, respectively.

The decider 330 determines whether to register the named entities recognized by the named entity recognizer 320 in the named entity dictionary 160 based on the first and second scores. For example, if the sum of the first and second scores exceeds a predetermined threshold, the decider 330 may decide to register the recognized named entities in the named entity dictionary 160. The threshold may be set or changed arbitrarily by the person that constructs the named entity dictionary 160.

Now a description will be made of a method for constructing a named entity dictionary according to an exemplary embodiment of the present invention.

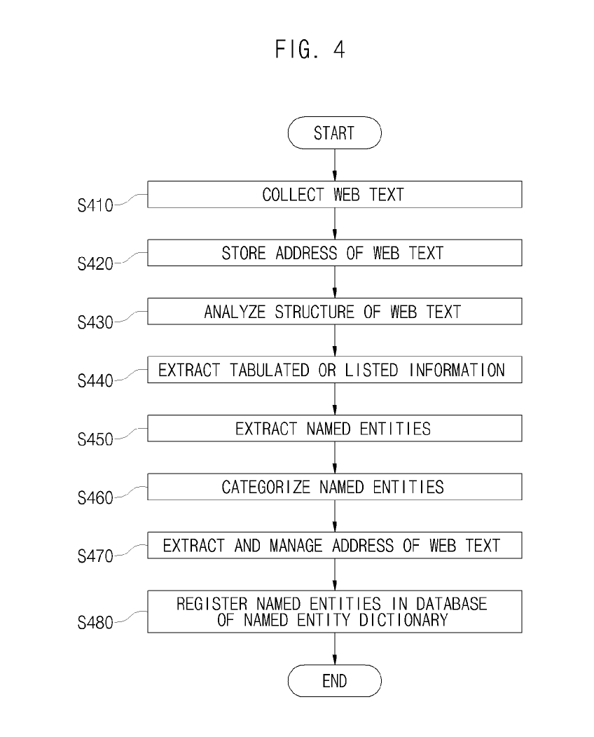

FIG. 4 is a flowchart illustrating a method for constructing a named entity dictionary according to an exemplary embodiment of the present invention.

Referring to FIG. 4, the system collects Web text in step S410. The Web text may be collected from a URL that the person wanting to construct the named entity dictionary 160 has entered, or from a pre-stored URL in the system. The pre-stored URL may be a URL from which a named entity was extracted and stored in the named entity dictionary 160.

The system extracts the URLs of the collected Web text, makes a list of the URLs, and manages the addresses of the Web text in the URL list, for use in collecting named entities later according to the present invention in step S420.

The system analyzes the structure of collected Web text in step S430 and extracts tabulated or listed information in step S440. Specifically, the system determines whether the Web text includes tabulated or listed information by HTML parsing and extracts the tabulated or listed information in the presence of the tabulated or listed information. As illustrated in FIG. 2, the Web text includes the tabulated information 200. In this case, the tabulated information 200 extracted from a Web page is given as follows.

Extracted tabulated information (S440)
<header> apartment name</header>
<data>
550 Moreland
Normandy Park
Vista Pointe
. . .
Domicilio
</data>

In step 450, the system extracts named entities from the extracted tabulated or listed information. For example, the system evaluates the probability of a named entity being included in the above tabulated information as a score (a first score) by analyzing the header information of the tabulated information. In this case, the system evaluates the ratio of recognized named entities as a score (a second score). The result of evaluating the first score and performing named entity recognition for the information extracted in step S430 is given below. In an exemplary embodiment, a first score of 80 is given to the tabulated information.

Scored (S450)
<header>apartment name</header>→AF_BUILDING (Score 80)
<data>
550 Moreland→named entity recognized: AF_BUILDING
Normandy Park→named entity recognition failed
Vista Pointe→named entity recognized: AF_BUILDING
. . .
Domicilio→named entity recognized: OGG_BUSINESS
</data>

Subsequently, the system determines whether to register the recognized named entities in the named entity dictionary 160 based on the first and second scores. For instance, only if the sum of the first and second scores exceeds a predetermined threshold, the system may decide to register the recognized named entities in the named entity dictionary 160.

After the named entities to be registered in the named entity dictionary 160 are completely extracted, the system may classify the categories of the named entities according to the result of step S450 in step S460. For instance, since one of the named entities recognized in step S450 is a category for other named entities, named entities may be selected for the category. The named entities for which categories have been decided in step S460 are given as follows.

Categorized Named Entities (S460)
<ne_list category=‘AF_BUILDING’>
550 Moreland
Normandy Park
Vista Pointe
. . .
Domicilio
</ne_list>

After the named entities are extracted and categorized, the system determines that the Web text includes named entities and manages the URL of the Web text separately in step S470. The system may collect Web text linked to the Web text using the separately managed URL.

In step S480, the system registers the categorized named entities in the named entity dictionary 160.

As is apparent from the above description, a named entity dictionary can be constructed more accurately and easily from Web text including information of a specific format such as a table or a list according to the exemplary embodiments of the present invention.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for constructing a named entity dictionary, comprising:
analyzing a structure of collected Web text;
extracting tabulated or listed information from the Web text;
extracting a named entity from the tabulated or listed information;
categorizing the extracted named entity; and
registering the categorized named entity in a named entity dictionary.

2. The method according to claim 1, further comprising extracting an address of the Web text and storing the extracted address.

3. The method according to claim 1, wherein the named entity extraction comprises:
evaluating a probability of a named entity being included in the tabulated or listed information as a first score by analyzing a header of the tabulated or listed information; and
performing named entity recognition on the tabulated or listed information and evaluating a ratio of recognized named entities as a second score; and
determining to register the recognized named entities in the named entity dictionary based on the first and second scores.

4. The method according to claim 3, wherein the determination comprises:
summing the first and second scores; and
determining to register the recognized named entities in the named entity dictionary, if the sum exceeds a predetermined threshold.

5. The method according to claim 1, further comprising extracting and managing an address of the Web text including the categorized named entity.

6. A system for constructing a named entity dictionary, comprising:
a Web text collector for collecting Web text;
an information extractor for extracting tabulated or listed information from the Web text;
a named entity extractor for extracting a named entity from the tabulated or listed information; and
a named entity dictionary for storing the extracted named entity

7. The system according to claim 6, further comprising an address extractor for extracting an address of the Web text and storing the extracted address.

8. The system according to claim 7, wherein the address extractor transmits the extracted address to the Web text collector.

9. The system according to claim 6, wherein the named entity extractor comprises:
a header analyzer for analyzing a header of the tabulated or listed information included in the collected Web text;
a named entity recognizer for recognizing the named entity in the tabulated or listed information; and
a decider for deciding to register the recognized named entity in the named entity dictionary.

10. The system according to claim 9, wherein the decider decides to register the recognized named entity in the named entity dictionary based on a sum of a first score reflecting a probability of a named entity being included in the tabulated or listed information and a second score reflecting a ratio of recognized named entities in the tabulated or listed information.

11. The system according to claim 6, further comprising a category decider for categorizing the named entity, wherein the named entity dictionary stores the named entity by category.

12. The system according to claim 6, wherein the Web text collector separately manages the address of the Web text from which the named entity is extracted.
